(19) United States
(12) Patent Application Publication
(10) Pub. No.: US 2003/0046568 A1
(43) Pub. Date: Mar. 6, 2003

(54) Media protection system and method and hardware decryption module used therein

(76) Inventors: Christopher J. Riddick, Herndon, VA (US); Lan Huu Tran, Reston, VA (US)

Correspondence Address: Joseph G. Seeber, Esq., Post Office Box 750, Great Falls, VA, 22066, US

(21) Appl. No.: 10/041,981

(22) Filed: Jan. 9, 2002

Related U.S. Application Data
(63) Continuation-in-part of application No. 09/947,641, filed on Sep. 6, 2001.

(51) Int. Cl. G06F 12/14

(52) U.S. Cl. 713/193; 705/65

(57) ABSTRACT

In a media protection system and method, an original media item is encrypted before it is distributed. A digital encryption key for the media item is stored on the consumer's personal smart token. To play the media item, the user inserts the media item into his player along with his smart token, and the digital encryption key is extracted by a hardware decryption module (HDM) in the player (or host device), and is used to determine that the decryption key is linked to the HDM. Once that determination is made, the HDM decrypts the media item as it is played. The HDM provides a USB or other standard interface between a plug connected to the player (or host device) and a socket which receives the smart token. The HDM comprises a decryption processor, a control processor, an internal memory, an external interface, and a memory element, such as a read-only memory (ROM). The HDM is implemented as a self-contained, tamperproof subsystem of the media protection system with which it is associated.

### REFERENCE TO RELATED APPLICATION

This is a continuation-in-part (CIP) of Ser. No. 09/947,641 filed on Sep. 6, 2001, and assigned to the assignee of the present invention.

### TECHNICAL FIELD

The present invention generally relates to a media protection system and method for protecting data stored on or transmitted by electronic media, such as digital versatile disks (DVDs), compact disks (CDs), communications by satellite transmission, electronic mail over the Internet, electronic books and the like, from illegal copying or distribution. More particularly, the invention relates to a hardware decryption module (HDM) used in such a media protection system and method.

### BACKGROUND ART

The entertainment industry and others produce and distribute copyrighted material to consumers for profit. The artists who create this material receive payments for each copy of their work sold. Thus, efforts are made to protect the intellectual and creative property of these artists and publishers, and to ensure that the publishers and artists receive full remuneration for their work by minimizing the ability of organizations and individuals to circumvent the protections afforded copyright holders when their works are distributed to the public via electronic means.

There are two main classes of threat to the intellectual property rights of the publishers and artists. The first class is the pirate who obtains a copy of the original work (legally or illegally), duplicates it, and then distributes it for profit without permission from or payment to the copyright holders. The second class is the individual who acquires a copy of the work, and then makes copies to be distributed (for sale or for free) to others, such as friends and family. Both classes of threat are considered to be illegal and to deprive the copyright holder of compensation for the work. Although pirates have significantly greater resources at their disposal for acquisition and duplication of material, individuals can do significant financial damage by releasing an illegal copy to the Internet. In that case, the potential for lost revenue to the copyright holders may be significant—even greater than from pirates.

The pirate may obtain a copy of a work and apply significant resources to extract the copyrighted material. Once extracted, thousands of illegal copies can be produced. It may not be practical to prevent this, but it has been considered possible to tag the material with a watermark so that the source of the original copy can be determined. This technique can also be used to identify illegal copies. This aids in the apprehension and prosecution of pirates. Thus, the means for dealing with the pirate threat has been to place some barriers to copying, but to ensure that there is a mechanism for identifying pirated material and prosecuting those responsible.

The individual consumer, who may acquire a copy and make it available to thousands or millions of people simply by posting the material to the Internet, is a much more difficult threat to avert. Protections cannot be so cumbersome as to hamper the legitimate use of legally acquired material because that might cause consumers to refuse to purchase the material. On the other hand, the current system of unprotected distribution of material places no barriers in the way of the consumer who makes illegal copies. Also, once the copy is released, it is not possible to trace the source for prosecution.

Thus, there is a need not only for a system and method which will enable the apprehension and prosecution of illegal copiers, including pirates and individuals, but also for a system and method which will place a sufficient barrier to prevent the casual copier from illegally distributing intellectual property to friends and family and from posting such intellectual property to the Internet as well, while not imposing undue burdens on legitimate consumers. In that sense, a balance must be achieved.

Accordingly, such a system and method should provide legitimate consumers with the ability to purchase and enjoy copyrighted material in all of the environments in which they currently do so. For example, many people own a media player at home, one in their car, and maybe a third portable player they take with them for recreation. Current law permits such a person to purchase a single copy of a media item to be played on any of these devices. The consumer is permitted to make a copy for personal use only. However, the consumer may not copy the media item and distribute it to other family members, friends, or acquaintances, even if no money exchanges hands.

Today, the consumer can take the legitimate media item and play it in any of these devices without restriction. There is a need for a system and method which will provide media protection while ensuring that this is still possible, but which will make it impossible for the general consumer to make illegal copies of a media item to distribute to others. The system and method should also provide a mechanism which will permit the consumer to acquire other media players and to use those to play the media item, but which will restrict other people from playing the media item without the direct consent of the original purchaser.

### DISCLOSURE OF INVENTION

The present invention generally relates to a media protection system and method for protecting data stored on or transmitted by electronic media, such as digital versatile disks (DVDs), compact disks (CDs), communications by satellite transmission, electronic mail over the Internet, electronic books and the like, from illegal copying or distribution. More particularly, the invention relates to a hardware decryption module (HDM) used in such a media protection system and method. In the context of the present invention, the term “media” refers to any mechanism or mode of data transfer using electronic means. This includes, but is not limited to, DVDs, CDs, radio and microwave transmissions, and electronic mail.

The media protection system is a distributed system composed of several subsystems, each providing an element of the overall copy protection and enforcement mechanism. The system and method of the present invention are based upon the premise that encrypting an original media item before it is distributed is the most secure approach to preventing illegal copying. The media protection system provides the elements necessary to manage the distribution of encrypted media, and to ensure that, when a legal copy is sold, it is accessible only to the legitimate purchaser of the copy or to a limited set of secondary parties as defined by the publisher.

In accordance with an embodiment of the invention, the consumer purchases a copy of a copyrighted work or media item at a retail store. A video DVD is an example, but the concept and operation of the invention apply equally to a music CD, electronic book, or any other digital media. As the consumer proceeds through the checkout, the clerk scans the media item for the price and detaches a Companion Digital ID™ (CDI) from the packaging. The consumer presents his personal smart token to the clerk who inserts it into a point of sale (POS) reader along with the CDI™. The POS reader extracts a digital key from the CDI™ and merges it with the player list in the consumer's smart token. The POS reader then destroys the CDI™ and returns the smart token to the consumer. The digital key for the media item is now stored on the consumer's personal smart token merged with each of the player identifiers and inaccessible to any other person or device.

When the consumer returns home, he inserts the media item into his player along with his smart token, and the digital key is extracted and used to decrypt the encryption key for the material that is stored on the media item itself. Then, the player decrypts the media item as it is played. The consumer may remove the smart token, and the encryption key is stored in the player. If someone were to try to tamper with the player and attempt to extract the key, it would be erased. If the consumer wanted to play the media item in a player other than the one on his list at the time he bought the media item (e.g., he purchased a new player), he would insert his smart token in the new player and transfer its public key to his smart token. He then inserts the smart token into one of his currently authorized players and activates the NEW PLAYER function. This function generates a new set of records on the smart token encrypted with the public key of his new player and accessible only to his new player.

The discussion of the purchase of a media item raises the issue of how a consumer registers multiple devices that can read and decode the same media item. The system and method of the present invention provide a mechanism that embeds the decryption algorithm and a device-specific identifier in each player. Just as each network interface card today is initialized with a unique identifier, the system and method of the invention provide each player with a similar identifier. When the player is manufactured, it is packaged with a public/private key pair and a copy of the player's unique identifier. This key pair and identifier are called the Player Digital ID™ (PDI). When the consumer purchases the player at the retail store, he presents his personal smart token to the player and the player's public key is added to the smart token's player cache. Thus, a database of identifiers and player public keys is incorporated on the consumer's smart token as the PDI cache for use in the future when buying media.

When the consumer wishes to play the media item, he simply inserts the media item into the player and presents his smart token to the player's reader. The player extracts the merged digital key for the media item from the smart token and uses it to decode the encryption key stored on the media item itself. The encryption key is then cached on the player and used to decrypt the contents of the media item.

The consumer cannot share his smart token with someone else's player because the digital key is encrypted with the unique player public key from the consumer's own player. Anyone else's player will not be able to decode the digital key from the smart token, even if they are able to extract the encrypted digital key from the smart token. Likewise, if the consumer receives an illegal copy of a media item, it will not play on his player because the player's unique ID will not match an encrypted digital key from the smart token. Counterfeiting is not possible because the only source of the media private key is the CDI™ packaged with the original media item, and that is destroyed by the POS reader at the time of purchase. This makes mass distribution of counterfeited media extremely difficult due to the need to deal with the player's key (PDI) and the media item's CDI™.

As mentioned above, the system and method disclosed herein provide a mechanism whereby a decryption algorithm and a device-specific identifier, the PDI, are installed or embedded in each player authorized to play the media item. This capability and the hardware decryption component of the method and system disclosed herein are implemented by a hardware decryption module (HDM). In the latter regard, a key element of the media protection system and method is the requirement to link the media encryption key to a specific decryption device, making it impossible to decrypt on any other device. The HDM implements this requirement. The HDM may be embedded in playback or communication devices. It may also be portable and attached to any compatible device to permit decryption of media by the possessor of the HDM.

In the media protection system and method, there are two components necessary to successfully decrypt media, the HDM and the smart token. The smart token is a hardware device that contains encrypted keys for use in decrypting media by a specific HDM. The smart token is described in more detail below. It contains two data caches: an HDM PDI cache and a media key cache for each media item authorized for access by the possessor of the smart token. The media keys in the cache are encrypted by the public keys of the authorized HDMs.

There are many possible uses of the invention in the marketplace. Although the invention will provide protection of DVD and CD recordings, as described above, its use can also be extended to almost any form of electronic media distribution, such as electronic book distribution, Internet software and data distribution, library loan and distribution, and secure transmission of information to selected recipients over broadcast systems. Thus, the features of the invention can be implemented in a data distribution system wherein a point of distribution takes the place of the POS discussed above, the CDI™ is transferred electronically to the point of distribution and is then transferred by suitable means (e.g., a reader similar to the POS reader described above) to the smart token of the user. The encrypted media item is transferred separately to the user.

Therefore, it is a primary object of the present invention to provide a media protection system and method.

It is an additional object of the present invention to provide a system and method for protecting media, such as DVDs, CDs, electronic books, and the like, from illegal or unauthorized copying or distribution.

It is an additional object of the present invention to provide a system and method for protecting such media from illegal or unauthorized copying or distribution while not imposing undue burdens on legitimate consumers.

It is an additional object of the present invention to provide a system and method for protecting such media from illegal or unauthorized copying or distribution while preserving the ability of legitimate consumers to enjoy the protected material or subject matter in all of the environments in which they currently do so, and to use the protected material or subject matter in other media players acquired subsequent to purchase of the protected material or subject matter.

It is an additional object of the present invention to provide a hardware decryption module (HDM) which serves to link a media encryption key to a particular decryption device, thereby making it impossible to decrypt a media item on any device other than an authorized device.

It is an additional object of the present invention to provide an HDM which is installed or embedded in a decryption device.

It is an additional object of the present invention to provide an HDM which is externally attached to a decryption device.

The above and other objects, and the nature of the invention, will be more clearly understood by reference to the following detailed description, the drawings and the appended claims.

### BRIEF DESCRIPTION OF DRAWINGS

FIG. 1 is a flowchart of the process of producing protected media and the related keys.

FIG. 2 is a diagrammatic representation of the components of the inventive system as provided at a point of sale (POS).

FIG. 3 is a flowchart of the process of activation of the media at the POS.

FIG. 4 is a diagrammatic representation of a smart token used in the present invention.

FIG. 5 is a diagrammatic representation of the components of the inventive system as provided at a point of use (POU).

FIG. 6 is a flowchart of the process of media playback at the POU.

FIG. 7 is a flowchart of the process of fair use copying in accordance with the present invention.

FIG. 8 is a functional block diagram of the HDM of the present invention as connected externally to a host device.

FIG. 9 is a more detailed block diagram of the HDM of the present invention as connected to the host device.

FIG. 10A is a diagrammatic representation of a first embodiment of the HDM using the industry standard USB 2.0 interface and Series A plugs and sockets.

FIG. 10B is a diagrammatic representation of a second embodiment of the HDM using the industry standard USB 2.0 interface and Series A plugs and sockets.

FIG. 11 is a functional block diagram of the HDM of the present invention.

### BEST MODE FOR CARRYING OUT THE INVENTION

The invention will now be described in more detail with reference to the various figures of the drawings. In that regard, the following definitions are applicable to the terminology used in the disclosure of the invention set forth below.

The term “key” indicates a value used in the encryption algorithm to initiate the scrambling of the data. Keys are usually referred to by their length, such as 128-bit or 256-bit key. Key length is determined by the algorithm used and the desired strength of encryption. The longer key provides better protection at the expense of speed of the algorithm.

The term “public key” indicates a form of encryption in which a key is broken into two parts, a private part and a public part. The private part is known only to the owner of the data (in our case, the HDM controls the private key). The public part is made available to any party who wishes to communicate with the owner (in our case, the key token contains the public keys of all HDMs controlled by one person.

The term “CDI” indicates an element of the media protection system that enables senders and receivers to match up encryption keys of HDMs with those of the specific media items.

The term “media” indicates any physical form of digital information transport, whether it be magnetic disk, CD-ROM, DVD, radio, or satellite. The term “media” is used to refer to the digital information in a form amenable to transfer from the sender (seller) to receiver (buyer).

The term “player” indicates any device that is used to present media to a consumer. This may be a DVD player, a CD player, a radio receiver, or other device that reads media in some form.

The term “host” indicates a device that performs functions for a consumer such as a television, radio, DVD player, personal computer, or any other device that reads media in some form. Host and Player are used interchangeably.

The term “HDM” indicates a hardware decryption module. It may be installed or embedded in a host or player, or it may be attached externally. In either case, it implements an industry-standard interface between itself and the host device.

The term “PDI” indicates the player digital ID™, which is an element of the media protection system that uniquely identifies the player and contains the player's public/private key pair.

The media protection process begins at the publisher where the media are produced. Each copy of the media has an associated media label, L_{M}, and a unique public/private key pair, K_{PubM}/K_{PrivM}. Each copy of the media is encrypted using a unique key, K_{M}, associated with that particular media item and known only to the publisher. The encryption key, K_{M}, is then encrypted using the public key, K_{PubM}, and stored on the media item along with the protected work. The encryption key, K_{M}, is also referred to as the digital key for the media item. The media label, L_{M}, and the private key, K_{PrivM}, are written to a disposable media, such as a bar code strip or memory stripe card, attached to the packaging in which the media item is to be sold or distributed. These two items (L_{M} and K_{PrivM}) are referred to as the Companion Digital ID™, or simply the CDI™. Alternatively, the CDI™ may be stored in a database at the publisher for future use by a clearinghouse at the point of sale.

Each copy of the media item is uniquely encrypted, and can only be read after the private key, K_{PrivM}, is used to decrypt the media key K_{M}. Since each media item uses a different encryption key, only the copy associated with that key can be read, and all other media items are still protected by their own encryption keys. If someone were to make multiple copies of a media item and distribute them, they would not be readable.

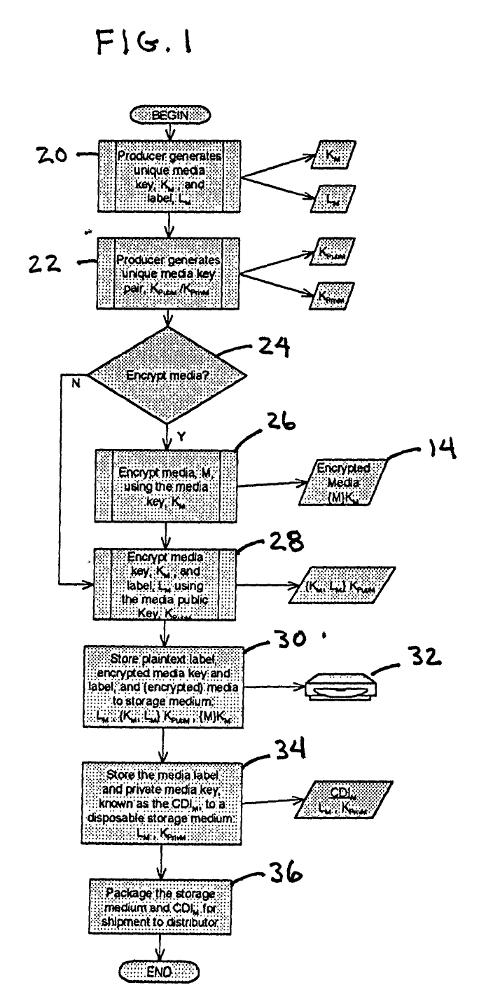

FIG. 1 is a flowchart of the process of producing protected media and the related keys. Referring to FIG. 1, in order to protect a media item in accordance with the invention, the following steps are performed.

(1) The producer prepares a media master by first generating a media label, L_{M}, and a media key, K_{M} (block 20).

(2) The producer generates a unique public/private key pair, K_{PubM}/K_{PrivM}, for the media item (block 22).

(3) If desired, the producer may encrypt the media item using the unique media key, K_{M}, known only to the producer (blocks 24 and 26), thereby producing an encrypted media item.

(4) The producer encrypts the media key, K_{M}, and the label, K_{L}, using the media's public key, K_{PubM}, to get the following: {K_{M}, L_{M}} K_{PubM} (block 28).

(5) The producer destroys the media key, K_{M}, and stores a plaintext copy of the media label, L_{M}, and the encrypted media key and label, {K_{M}, L_{M}} K_{PubM}, on the media item to get the following: L_{M}, {K_{M}, L_{M}}K_{PubM}; if the media item was encrypted with the media key, K_{M}, in step (3) above, then the producer also writes the encrypted contents to the media item (block 30).

(6) The producer writes the media private key, K_{PrivM}, and the media label, L_{M}, to a disposable medium to be incorporated into the packaging in which the media item will be distributed or sold (block 34). The private key is no longer needed, but may be archived for future retrieval should it be necessary to recover a media item encrypted with this key pair. The combination of media private key and media label on the disposable medium is called the Companion Digital ID™ (CDI), or simply CDI™, as stated above.

(7) The producer generate a media package insert, containing the CDI™, to be used at the POS, and packages the media item with its disposable medium for shipment to the distributor (block 36).

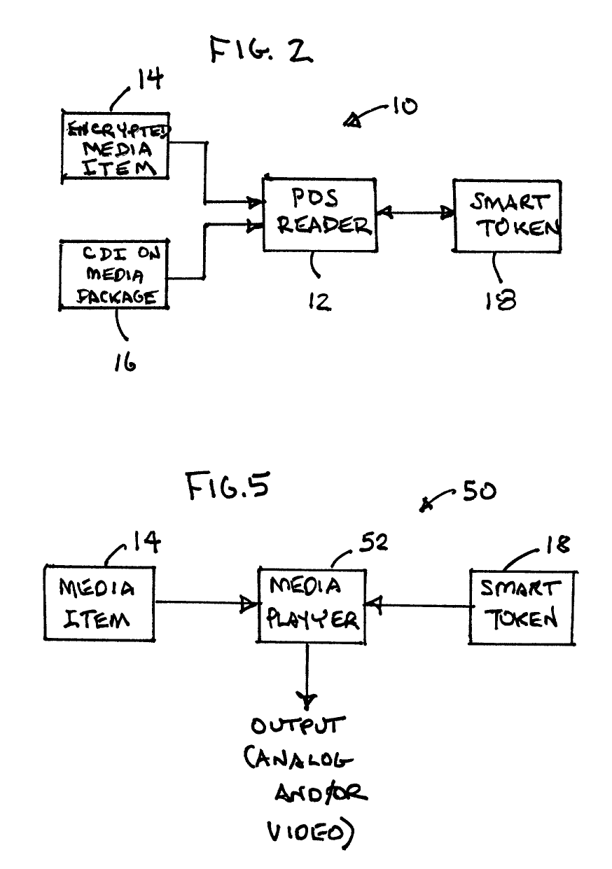

Upon shipment of the media item and its packaging to the POS, it is displayed for purchase by consumers. FIG. 2 is a diagrammatic representation of the components of the inventive system as provided at the POS.

Referring to FIG. 2, in accordance with the invention, the POS system 10 includes a POS reader 12 located at the POS. The encrypted media item 14 is displayed in its media packaging with its CDI™ 16 located on the package. A consumer desiring to purchase the encrypted media item 14 will carry a smart token 18 for use at both the POS and the POU.

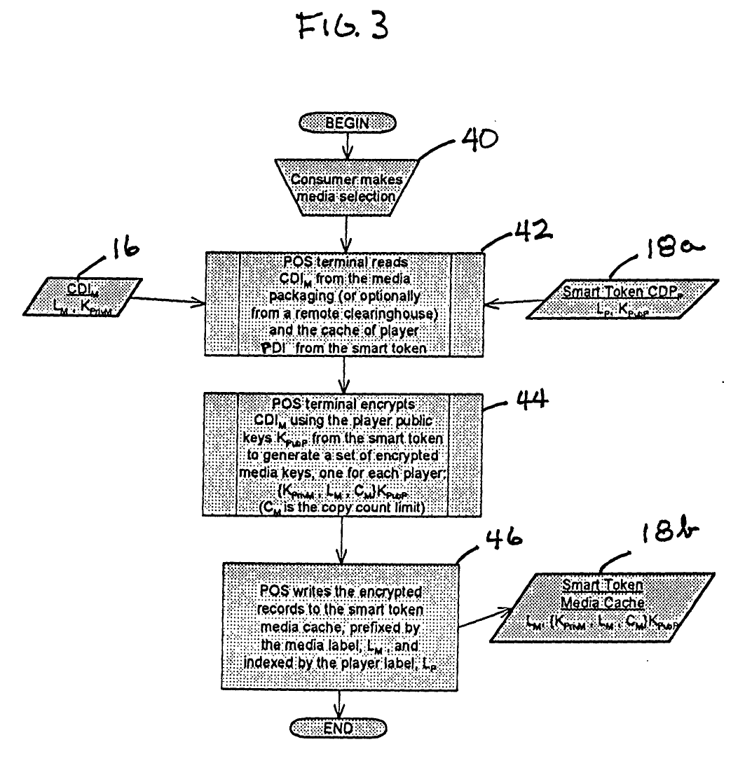

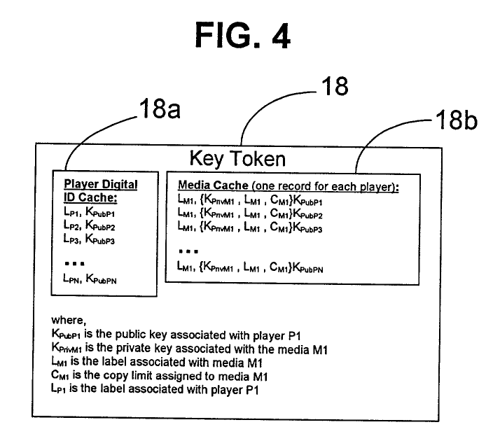

The inventive system and method ensure that the CDI™ is securely transferred to the purchaser's smart token by the POS reader 12, and encrypted using the public keys of the players owned by the consumer, thus eliminating the opportunity of the purchaser to make multiple copies since the CDI is locked on the smart token and only authorized players will be able to access the media CDI. The system and method of the invention, as implemented at the POS, will now be described with reference to FIG. 2, as well as to FIG. 3, which is a flowchart of the process of activation of the media at the POS, and FIG. 4, which is a diagrammatic representation of a smart token used in the present invention.

(1) The consumer enters a store with his smart token 18 containing a cache 18a of public keys, K_{PubPN}, for all players he owns.

(2) The consumer selects a media item (block 40 of FIG. 3), and presents its package CDI_{M} 16 (which contains the media label and the media private key) to the POS reader 12, and inserts his smart token 18 into the reader 12.

(3) The POS reader 12 reads the CDI_{M} and extracts the media label, L_{M}, and the media private key K_{PrivM} (block 42). Alternatively, the CDI™ may be securely stored at a remote clearinghouse, to which the media label L_{M} is transferred for use in step (4) below.

(4) The POS reader 12 also reads the player cache 18a from the smart token 18 (block 42), and encrypts the media private key, K_{PrivM}, the media label, L_{M}, and the copy count, C_{M}, using the public key of each player to generate a set of encrypted keys as follows: {K_{PrivM}, L_{M}}K_{PubP} (block 44). This set is then written back to the media cache 18b of the smart token 18, and is indexed using the media label L_{M}, and the player label, L_{P}, as indices (block 46). The count, C_{M}, is reserved for use when copying a media item (block 46). The count determines the number of legitimate copies which may be made from the original media item purchased by the consumer. This number is configurable by the DVD manufacturer and defaults to 3. Alternatively, this operation could be performed securely at a remote clearinghouse and the CDI™ is never exposed to the consumer. The encrypted media cache is then returned to the POS from the clearinghouse.

(5) The CDI_{M} is then destroyed at the POS to prevent illegal copying.

Once the consumer purchases the media item at the POS, he transports it to the point of use (POU). FIG. 5 is a diagrammatic representation of the components of the inventive system as provided at a POU.

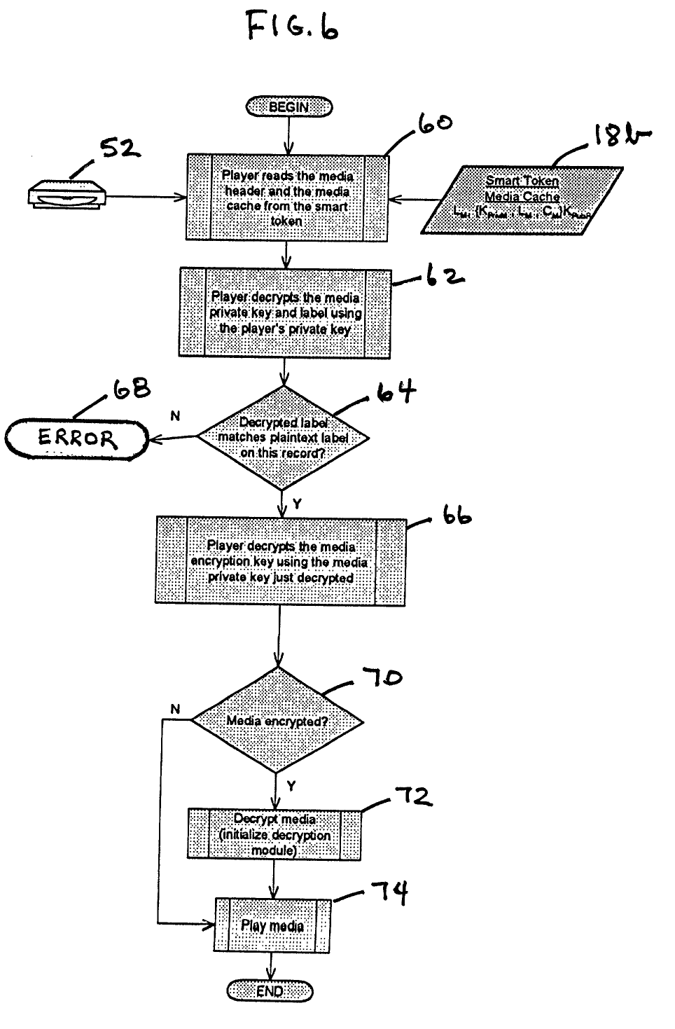

As seen in FIG. 5, the POU system 50 includes the consumer's media player 52 for playing the media item 14 with input from the consumer's smart token 18. The method and operation of the present invention at the POU will now be described with reference to FIG. 5, and to FIG. 6, which is a flowchart of the process of media playback at the POU.

Operation of the system and method of the present invention at the POU proceeds as follows.

(1) When the consumer wishes to play the media item 14, he inserts it into his player 52 along with his smart token 18. The player 52 opens the smart token 18, and searches the media cache for a match with the media item label, L_{M}, read from the header of the media item (block 60).

(2) The player 52 may find one or more entries in the cache for the media label, but only the one with the player's label, L_{P}, will be used. The player 52 uses its internal private player key, K_{PrivP}, to decrypt the media encryption key, K_{PrivM}, retrieved from the smart token media cache to obtain the following: {{K_{PrivM}, L_{M}, C_{M}}K_{PubP}}K_{PrivP}=K_{PrivM}, L_{M}, C_{M} (block 62). The count, C_{M}, retrieved from the decrypted record is not used during playback, but is reserved for use when copying the media item 14. The count determines the number of legitimate copies which may be made from the original media item 14 purchased by the consumer. It should be noted that the player key K_{PrivP} for player 52 is actually stored securely in the HDM, and all of the encryption operations are performed by the HDM for the player 52 (as described in more detail below).

(3) If the decrypted media label L_{M} from the smart token 18 matches the label from the media item 14 itself, then playing may proceed because the decryption was successful (block 64).

(4) The K_{PrivM} is used to decrypt the media key read from the same record on the smart token 18 to obtain the following: {{K_{M}, L_{M}}K_{PubM}}K_{PrivM}=K_{M}, L_{M} (block 66).

(5) If the media item 14 was encrypted, then K_{M} is used to decrypt the contents of the media item 14 before or during playback (blocks 70 and 72), and the media item 14 is then played (block 74).

The system and method of the present invention require that all players, such as player 52 (FIG. 5), have an embedded Player Digital ID, PDI, that is generated at the time of manufacture of the player 52 and permanently stored in a secure memory in the player 52. The PDI contains a player label, L_{P}, and a public/private key pair, K_{PubP}/K_{PrivP}. Anyone may insert his or her smart token 18 into the player 52 and load the player's public key onto the smart token 18 using the RETRIEVE PDI function. Once the public key is on the smart token 18, the smart token may be taken to any POS reader 12 when purchasing the media item 14, and have the media item's private key encrypted using the player's public key, as described above. This permits anyone who purchases a legitimate copy of a media item 14 to play it on this particular player 52.

In the preferred embodiment of the invention, the embedded PDI is implemented in a tamperproof hardware module which can be either permanently wired into the player circuitry, or portable and plugged in using an industry-standard device interface, such as PCMCIA or USB. Regardless of the mechanism used to store and protect the PDI, all embedded PDI subsystems must contain the following functionality in a self-contained, tamperproof package:

(1) Store the player PDI on the subsystem along with its associated public key. The information stored will be: L_{P}, K_{PrivP}, K_{PubP}. This includes the player label, its private key, and its public key.

(2) Support the following functions when commanded through the external interface: RETRIEVE PDI, INITIALIZE DECRYPT, DECRYPT, and MAKE_COPY. RETRIEVE PDI returns the player label and the public key portion of the key pair to the requesting device. INITIALIZE DECRYPT receives an encrypted media key, decrypts it using the internal private key, and then places the media key into the decryption circuitry in preparation for decrypting the data stream to follow. The DECRYPT function takes a stream of bytes off the input register and decrypts them using the initialized decryption circuitry in the tamperproof subsystem. The MAKE_COPY function uses the media copy limit count to authorize a different consumer to access the media.

(3) Retain the media key in internal memory on the subsystem until power is removed or the next INITIALIZE DECRYPT command is received.

(4) Perform decryption functions using any standard encryption algorithm, such as AES, DES, or Triple DES.

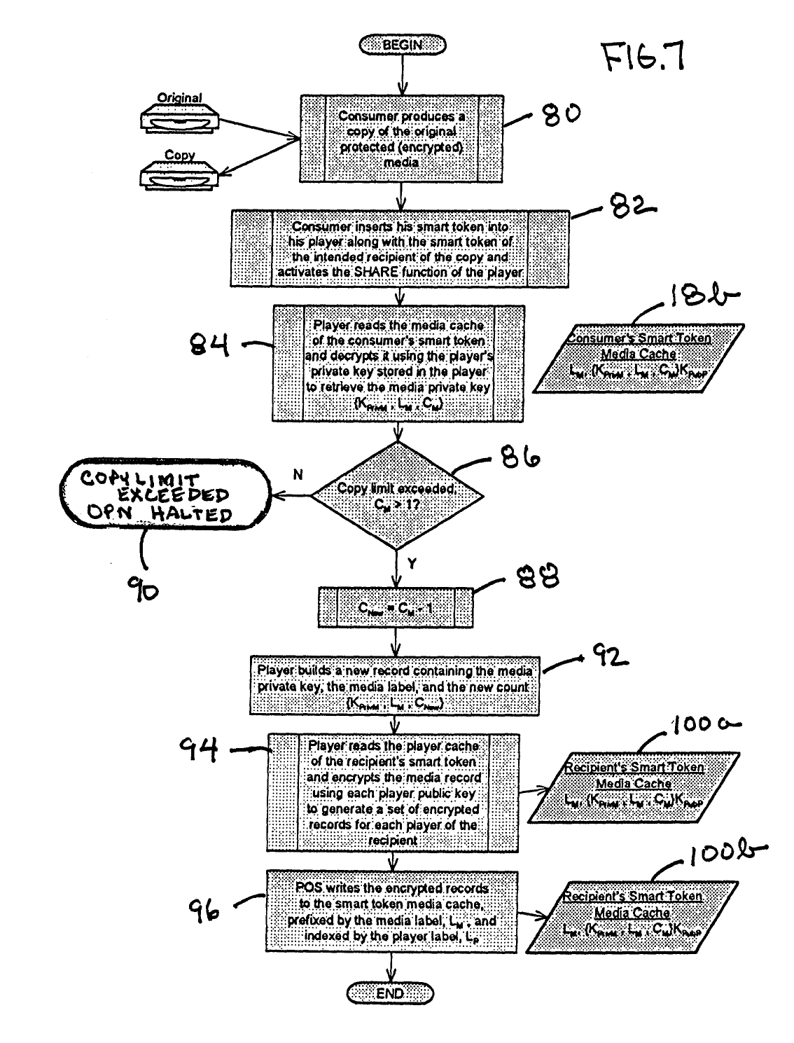

The system and method of the present invention permit consumers to make copies of a media item for backup and personal use, or to share a media item or items with a limited number of persons (in the example given above, limited to three copies). This maintains a balance between the rights of the intellectual property owner under copyright law and the rights of the purchaser to use the products. Referring to FIG. 7, personal use copying works in the following manner:

(1) A consumer who owns a legitimate copy of a media item 14 (FIG. 5) wishes to make a copy for a friend to view. The consumer understands that he is limited to only three such copies. The consumer produces a copy of the media item 14 using any generally available copy utility for a personal computer or other duplication device (block 80). The copy will be indistinguishable from the original.

(2) The consumer must now transfer the right to view the media item 14 from his smart token to his friend's smart token 18. This is done using the consumer's player 52 by inserting both tokens 18 into the player 52 and pressing the SHARE button or activating the SHARE function (block 82).

(3) The player 52 reads the media cache 18b (FIG. 4) from the consumer's smart token 18 and locates the player's own copy of the encrypted media key record, {K_{PrivM}, L_{M}C_{M}}_{KpubP} (block 84). Since this player 52 is the legitimate user of this record, it may decrypt this record using its private key, stored only in the player's protected memory.

(4) Once decrypted, this record reveals the private key for the media item, the media label, and the media count. The player 52 first checks the count (block 86). If it is greater than or equal to 1, then it decrements the count, and proceeds (block 88). If the count is zero, then the consumer has already exhausted his legal copy limit, and the key duplication process is immediately terminated (block 90).

(5) The player 52 builds a new record containing the media private key, the media label, and the new count (block 92). The player 52 then reads the player cache 18a from the friend's smart token 18, and uses the public keys from this cache to generate a set of encrypted records for this media item, and stores them in media cache 98a or 98b of the friend's smart token in the same manner as was described above (blocks 94 and 96).

(6) Now, the friend's smart token has a set of encrypted keys for the media item 14 to match each player that he owns, except for the fact that the media count has been decremented by 1. If the friend were to make a copy of the media item 14 and to pass it on to someone else, the count would again be decremented, and ultimately the legal copy limit would be reached and further copying prevented.

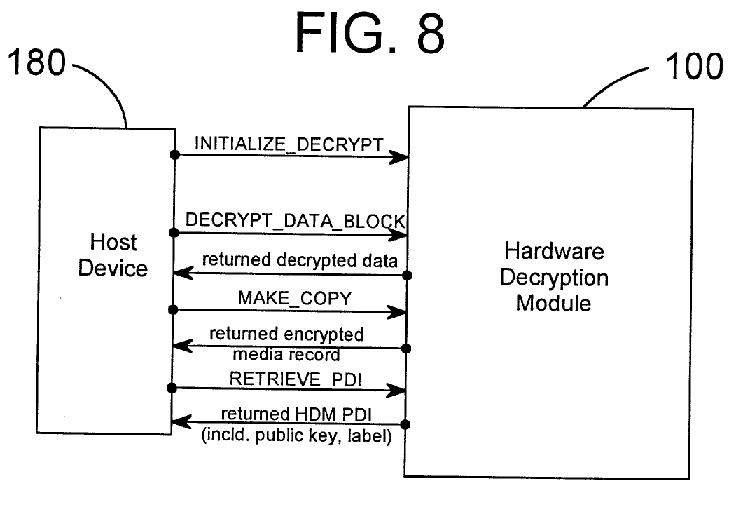

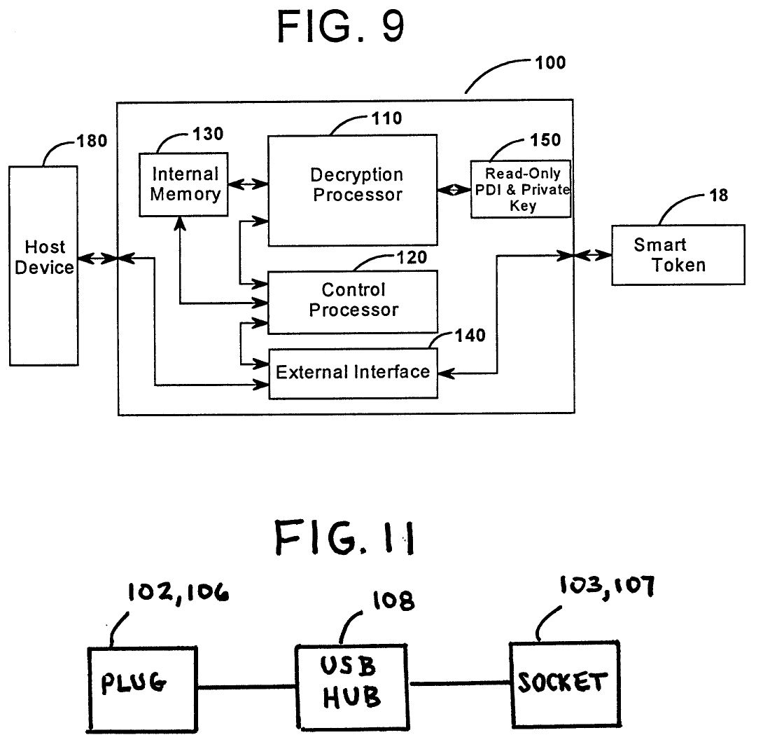

The HDM of the present invention will now be described with reference to various figures of the drawings, among which FIG. 4 is a diagrammatic representation of a smart token used in the present invention, FIG. 8 is a functional block diagram of the HDM of the present invention as connected externally to a host device, and FIG. 9 is a more detailed block diagram of the HDM of the present invention as connected to the host device.

Referring to FIGS. 4, 8 and 9, the smart token 18 contains a player PDI cache 18a and a media cache 18b, the latter containing one record for each authorized player. In accordance with the invention, the HDM 100 (described in more detail below) has memory capability sufficient to provide an HDM cache identical to the caches 18a and 18b of the smart token 18. Effective decryption of media requires that the HDM 100 and the smart token 18 contain the appropriately encrypted media key for that combination of HDM and media key. These core components of the media protection system result in an unprecedented consumer-oriented encryption product enabling secure distribution of all types of digital media.

Referring to FIGS. 8 and 9, the HDM 100 is a self-contained decryption module that is embedded in a host (or player device) 180 or externally attached thereto for decrypting data. Furthermore, the HDM 100 presents a single, industry-standard interface to the host 180. As indicated above, the host 180 may be a player device, a personal computer, or any other system that reads media and presents the information to a consumer or to another system. The hardware decryption module 100 includes the following elements: decryption processor 110, control processor 120, internal memory 130, external interface 140, and a memory element, such as a read-only memory (ROM) 150, for storing the HDM PDI.

All communication with the HDM 100 is over the external interface 140. Both commands and data pass through the external interface 140. The HDM 100 does not initiate any action without a command from the host 180. Should the HDM 100 be disconnected from the external interface 140, it will immediately erase its internal memory 130 (including any decryption system temporary storage) so as to prevent compromise of media keys. If the casing of the HDM 100 is tampered with (e.g., by an attempt to pry it open), it will also erase its internal memory 130 (including any decryption system temporary storage). Thus, the HDM 100 is a self-contained decryption system in a tamper-proof package.

The HDM 100 provides a tamperproof, reliable decryption system for use in one-way media transfer. The HDM 100 is principally used in situations where the sender cannot trust the receiver to protect the decrypted media and the media key. Distribution and sale of DVDs or CDs would be an example of such an application, as explained above. A situation in which the HDM 100 is not required is one wherein the receiver of encrypted data can be relied upon to protect the private key of the decryption system in software. In this case, the private key might be stored on another smart token in a manner similar to storage in a media key cache. This would most likely take place in the case of private, one-way broadcast communications.

The HDM 100 may be implemented as a single chip integrated circuit, or it may be composed of separate components configured as a unit and embedded in a tamperproof casing. The decryption processor 110 may implement any industry-standard encryption algorithm, such as the Data Encryption Standard (DES), the Triple-DES, and the Advanced Encryption Standard (AES). The preferred embodiment is the AES because it provides the most secure system available in the commercial market today.

Providing a tamperproof HDM removes one of the weaknesses in the current regional codes and content scrambling system for DVDs. In both technologies, enterprising programmers have reverse engineered the protection system and compromised the media encryption keys, rendering them virtually useless as a content-protection system.

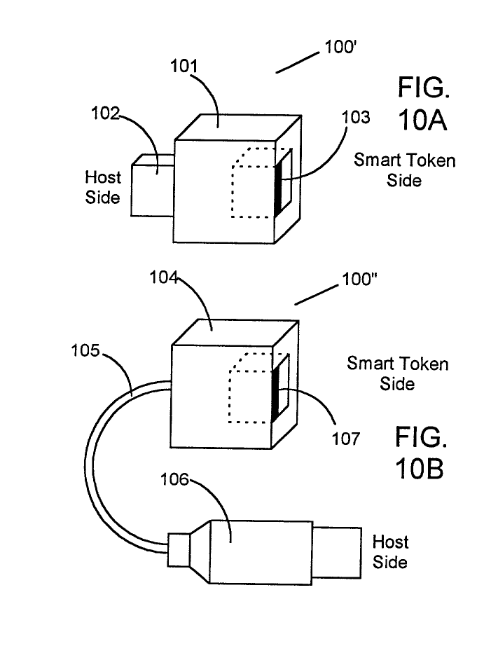

The HDM 100 is designed in such a fashion that it simply plugs into a standard interface for peripheral devices, such as the interface 140 discussed in more detail below with reference to FIGS. 10A and 10B. The interface 140 accepts commands and a stream of encrypted data. The decrypted data stream is returned over the same standard interface 140.

The actual media key is loaded into the HDM 100 by inserting the user's smart token 180 into a socket (discussed in more detail below) on the HDM 100. Once the smart token 180 is inserted, the HDM 100 reads the encrypted media keys into its internal, tamperproof memory 150 where they are decrypted by decryption processor 110 of the HDM 100 in correspondence to the public key used to encrypt the media keys. Thus, in addition to ensuring that the actual media keys are never exposed, implicit authentication of the recipient of the encrypted media is obtained because the physical possession of the HDM 100, which is tamperproof and copy-proof, identifies the recipient as an authorized recipient.

Without the HDM 100, the recipient's private key would have to be stored in a form that could be protected until needed. Whenever it were used, it would have to be protected from copying. This is not a problem if the recipient can be trusted to protect the key, and if the media is only intended for this one recipient. However, if multiple recipients were intended, then anyone could compromise the security of the encryption by revealing the key. Thus, software decryption is not useful for protection of mass-market, consumer-oriented media like audio CDs and DVDs.

Referring to FIG. 8, which is a functional block diagram showing the interconnection of the HDM 100 and a host device 180, the various functional commands which pass between those two elements will be explained.

The INITIALIZE_DECRYPT command is transmitted by the host device 180 to the HDM 100 and causes the HDM 100 to erase its internal memory, and specifically the key cache, and to reset the decryption processor 110. This prepares the HDM 100 to begin to receive blocks of encrypted data. Along with this command, the host 180 passes the following data to the HDM 100:

(1) An encrypted media record containing the media key, media label, and copy limit. This record is encrypted with the HDM's public key so that only this particular HDM is able to decrypt the record and retrieve the media key.

(2) A clear text media label as read by the host device 180 from the media header.

The DECRYPT command initiates the transfer of an encrypted block of data from the host 180 to the HDM 100. The HDM 100 decrypts the data and returns it to the host 180. This command consists of a block of data and the decrypt command. Decrypted data is returned as a block to the host 180.

The RETRIEVE_PDI command causes the HDM 100 to transfer the HDM's PDI to the host 180 from its internal read-only memory 150. This command is used by the host 180 when a consumer wishes to initialize a smart token 18 with this HDM's identifying information in the form of the CDI. The HDM PDI includes the HDM public key and the HDM label. The HDM private key is never returned to the host 180, and is always protected in the tamper-proof HDM module 100.

The MAKE_COPY command instructs the HDM 100 to take a given media encrypted record (media key, media label, and copy limit), decrypt it using the HDM's private key, verify the copy limit, decrement the copy limit, encrypt the result along with the media key and media label, and return the resulting encrypted record to the host 180. The host 180 can then write this record to a new smart token so as to provide for authorized copying of a media item. At no time does the media key become exposed outside the HDM 100, and only the HDM 100 can verify the copy limit to ensure that the copy limits are enforced.

If a host attempts to make an illegal copy for another player, the result will be a useless media key because the other player (having a different HDM) will not be able to decrypt the media record in question. Only when the media key is provided to the other HDM, encrypted in that HDM's public key, will it be able to extract it and play the media item.

Thus, this MAKE_COPY command implements a strong encryption, copy limit function tied to specific players (HDMs).

The HDM 100 will implement an industry-standard interface with the host 180. It must be capable of transferring data at a minimum of 10 Mbps between the host 180 and the HDM 100. It also provides an interface for the smart token 18 that contains the cache 18a of player keys and the cache 18b of media keys.

FIG. 10A is a diagrammatic representation of a first embodiment of the HDM using the industry standard USB 2.0 interface and Series A plugs and sockets. As seen therein, the HDM 100′ has a case 101 which is provided, on the host side, with a plug (preferably, a USB Series A plug) 102 for connection to the host 180, and which is provided, on the smart token side, with a socket (preferably, a USB Series A socket) 103 for receiving the smart token 18.

FIG. 10B is a diagrammatic representation of a second embodiment of the HDM using the industry standard USB 2.0 interface and Series A plugs and sockets. As seen therein, the HDM 100″ has a case 104 which is connected, on the host side, via a cord or cable 105 to a plug (preferably, a USB Series A plug) 106 for connection to the host 180, and which is provided, on the smart token side, with a socket (preferably, a USB Series A socket) 107 for receiving the smart token 18.

The preferred embodiments of this invention use the USB 2.0 high speed interface (480 Mbps) and support message and stream transfers per the USB 2.0 standard. As mentioned above, a USB Series A plug 102 or 106 is provided to connect to the host 180, and a USB Series A socket 103 or 107 is provided for reception of the smart token 18.

FIG. 11 is a functional block diagram of the HDM of the present invention. As seen therein, the HDM 100 includes a USB hub 108 which interconnects the plug 102 or 106 with the socket 103 or 107.

Thus, the preferred embodiment of the HDM 100 includes and implements the internal USB hub 108 which passes the data from smart token 18 through the HDM 100 and via the plug 102 or 106 back to the host 180 as a separately addressable logical device. Thus, the host 180 may command the HDM decryption services separately from the reading and writing of the smart token 18.

The HDM 100 is tamperproof, and is impervious to probing by external test equipment. It does not expose the decryption key cache at any time. Should the case 101 or 104 be breeched or physically probed, it immediately erases the entire contents of the decryption key cache, rendering the HDM 100 useful for further decryption.

The HDM 100 provides media keys or its private key to the external interface 140. They are only available to the internal circuitry of HDM 100, and they are immediately erased upon removal of power to the HDM 100 or upon receipt of the INITIALIZE_DECRYPT command.

The HDM 100 receives its power directly from the host 180. Should the plug 102 or 106 of the HDM 100 be removed from the host socket (not shown), it immediately erases its decryption key cache.

As stated above, the preferred embodiment of the HDM 100 provides a USB series A socket 103 or 107 in its case 101 or 104 to receive the smart token 18 containing the key cache of the user. The socket 103 or 107 supports the basic functionality of the smart token 18 so as to enable it to send commands to and receive data from the smart token 18. It provides the power required by the smart token 18. The HDM 100 serves as a USB hub 108 for socket 103 or 107, making the smart token 18 accessible by the host 180.

The HDM 100, whether embedded in the host 180 (as shown in FIG. 10A) or attached thereto via the industry-standard interface 105,106 (as shown in FIG. 10B), takes a block of data, decrypts it, and returns the decrypted data to the host 180.

In operation, commands and data are received over the industry-standard interface 105,106 from the host 180 by the external interface 140 (FIG. 9). If the commands and data are addressed to the decryption subsystem, the external interface 140 passes them on to the control processor 120. If the commands and/or data are destined for the smart token 18, then the external interface 140 passes them through to the smart token 18. The host 180 sees two devices on its standard interface. In the preferred embodiment using the USB 2.0 standard, the HDM 100 serves as and/or provides a USB hub 180 to which the decryption subsystem and the smart token 18 are attached. The decryption subsystem and the smart token 18 operate as USB devices, conforming to the USB standards.

When the host 180 is first activated, it checks its interface (not shown) with the HDM 100 to determine if a smart token 18 has been inserted. If there is none, then only unprotected media may be played. If a smart token 18 is inserted in the socket 103 or 107, then the host 180 reads the media cache 18b from the smart token 18 and stores it in temporary memory.

When the host 180 detects a media item, such as a DVD, it reads the media header, recognizes that it is a protected item, and initializes the decryption subsystem pf HDM 100 to prepare for playback. The host 180 sends an INITIALIZE_DECRYPT command and the encrypted media record from its temporary memory, matching the label L_{M1} of the media to the HDM 100. If there is no matching media record for the media label L_{M1}, the player generates a signal that it is not authorized to play that media item. The external interface 140 passes the command and data to the control processor 120, which stores the data in internal memory 130, and sends the command to the decryption processor 110. The decryption processor 110 retrieves the encrypted media record from internal memory 130 and reads the private key K_{PrivMa1} from the read-only memory 150 of the HDM 100. It decrypts the media record using its private key K_{PrivM1}. If the decrypted media label matches the media label provided in the INITIALIZE DECRYPT command, then the decryption processor 110 completes the initialization of the decryption by loading the decrypted media key in preparation for the first block of data. It returns a success message to the host 180 when this process is complete.

When the decryption system is initialized, the host 180 begins sending blocks of data from the media 14 to be decrypted. As each block is decrypted, the decryption subsystem returns it to the host 180 via the control processor 120 and the interface 140. This process cycles continuously until the media 14 has been fully decrypted. At no time is the media key ever exposed outside the decryption processor 110.

The HDM PDI must be loaded onto a smart token 18 in order for the user of the smart token 18 to be able to acquire new protected media items. Whenever host 180 detects that a smart token 18 has been inserted into the HDM 100, the host 180 reads the player cache 18a and the media cache 18b from the smart token 18. If the player cache 18a does not contain the PDI for this host 180 (i.e., it does not find a PDI for the attached or embedded HDM 100), it writes a copy of the PDI for HDM 100 onto the player cache 18a for future use.

When a consumer wishes to make a legal copy of a media item 14, assuming that some limited number of original copies has been permitted by the copyright owner, he or she invokes the player's copy function. The player requests the consumer to insert the media 14 to be copied and the smart token 18 of the authorized user of this media. The player reads the media record for this item and player from the smart token 18. The player prompts the consumer to replace the smart token 18 with one that contains the PDIs of players to be authorized to access the new copy. The copy function initiates a MAKE_COPY command to the HDM 100, passing the subset of the cache of player records for this smart token 18 to the HDM 100 along with the encrypted media record for this item, and the media label. The control processor 120 stores this data in internal memory 130. The decryption processor 110 then verifies that the encrypted media record does, in fact, correspond to this media item 14 and this HDM 100, and decrements the copy limit count. The decryption processor 110 stores the decrypted media key in internal memory 130. The decryption processor 110 then encrypts the media key using each of the PDIs for players provided from the new smart token 18. Once a record is created for each new player for this media item 14 (containing the media key, media label, and new copy limit), the encrypted records are returned to the player via the control processor 120 and the external interface 140. The player then writes these new records to the smart token 18 to be authorized the new copy.

The HDM 100 performs all copy authorization functions in a tamperproof environment, ensuring that the owner of the original media can control the making of legitimate original copies, and ensuring that the copy limits are enforced.

The following features fall within the scope of the inventive system and method:

(1) a system to protect the transmission and storage of intellectual property;

(2) the provision of a Companion Digital ID™ or CDI™ associated with any media item or intellectual property in electronic form;

(3) the transmission of the CDI™ via a medium which can be destroyed once it is read by a point of sale (POS) reader;

(4) the transmission of the CDI™ via electronic means using secure communications over the Internet, or over another communications system, from a secure clearinghouse to a POS reader, thereby further increasing the security of the transfer of the CDI™ to smart token;

(5) the use of a POS reader to complete the transfer of the CDI™ to a smart token, and then to destroy the CDI™ media item to prevent unauthorized copying;

(6) the use of a smart token to store the cache of player public keys owned by the consumer and a cache of encrypted CDIs for each media item (e.g., CDROM or DVD) owned by the consumer;

(7) the use of an embedded private key from a public/private key pair in the electronic circuitry or read-only memory of each player or playback device for the purpose of decrypting the CDI™ from the smart token media cache;

(8) the use of a tamperproof hardware decryption module with an industry standard interface (such as PCMCIA or USB) that can be embedded in the circuitry of a host, or plugged into an interface of the host, such module performing the actual data or media decryption function using a supplied encrypted media key, and containing the player private key which is used to decrypt the media key in order to initialize the decryption circuitry, and such module performing the following functions: RETRIEVE PDI, INITIALIZE DECRYPT, DECRYPT, and MAKE_COPY;

(9) the use of the player or playback device public key to encrypt the CDIs for each media item owned by the consumer and stored on the consumer's smart token;

(10) the use of the encrypted CDIs and a maximum copy count stored on the smart token to limit the number of copies that may be generated by a consumer for any player other than his or her own player; and

(11) the provision of an intellectual property and media protection system or method consisting of four elements: the producer's media encryption key and associated public/private key pair for securing the media, the special POS reader to transfer the CDI™ from the media package or a clearinghouse to the consumer's smart token, the smart token itself used to maintain the cache of player public keys and encrypted CDIs for all authorized media, and the special players or playback devices with embedded private keys from a public/private key pair used to decrypt the CDIs from the smart token cache, and then to decrypt and play back the protected media item.

While preferred forms and arrangements have been shown in illustrating the invention, it is to be understood that various changes and modifications may be made without departing from the spirit and scope of this disclosure.

1. A system for reading data from a protected media item, comprising:
a smart token carried by a user and containing a decryption key linked to a specific decryption device;
a hardware decryption module connectable to said smart token and functioning as a decryption device when the decryption key is linked to said hardware decryption module; and
a host device connectable to said hardware decryption module so that said hardware decryption module serves as a decryption device for said host device when the decryption key is linked to said hardware decryption module.

2. The system of claim 1, wherein said hardware decryption module reads the decryption key from the smart token when said smart token is connected to said hardware decryption module, determines whether the decryption key is linked to the hardware decryption module, and decrypts data from the protected media item prior to providing it to said host device when it is determined that the decryption key is linked to the hardware decryption module.

3. The system of claim 2, wherein said hardware decryption module comprises an external interface connected between said smart token and said host device.

4. The system of claim 3, wherein said hardware decryption module further comprises a control processor connected to said external interface for controlling operation of said hardware decryption module.

5. The system of claim 4, wherein said hardware decryption module further comprises a decryption processor connected to said control processor for decrypting the data from the protected media item prior to providing it to said host device.

6. The system of claim 5, wherein said hardware decryption module further comprises a memory for storing decryption key information for comparison with the decryption key from the smart token so as to determine whether the decryption key is linked to the hardware decryption module.

7. The system of claim 2, wherein said hardware decryption module comprises a control processor for controlling operation of said hardware decryption module.

8. The system of claim 7, wherein said hardware decryption module further comprises a decryption processor connected to said control processor for decrypting the data from the protected media item prior to providing it to said host device.

9. The system of claim 8, wherein said hardware decryption module further comprises a memory for storing decryption key information for comparison with the decryption key from the smart token so as to determine whether the decryption key is linked to the hardware decryption module.

10. The system of claim 2, wherein said hardware decryption module comprises a decryption processor for decrypting the data from the protected media item prior to providing it to said host device.

11. The system of claim 10, wherein said hardware decryption module further comprises a memory for storing decryption key information for comparison with the decryption key from the smart token so as to determine whether the decryption key is linked to the hardware decryption module.

12. The system of claim 2, wherein said hardware decryption module comprises a memory for storing decryption key information for comparison with the decryption key from the smart token so as to determine whether the decryption key is linked to the hardware decryption module.

13. The system of claim 1, wherein said hardware decryption module comprises an external interface connected between said smart token and said host device.

14. The system of claim 13, wherein said hardware decryption module further comprises a control processor connected to said external interface for controlling operation of said hardware decryption module.

15. The system of claim 14, wherein said hardware decryption module further comprises a decryption processor connected to said control processor for decrypting the data from the protected media item prior to providing it to said host device.

16. The system of claim 1, wherein said hardware decryption module further comprises a control processor connected to said external interface for controlling operation of said hardware decryption module.

17. The system of claim 16, wherein said hardware decryption module further comprises a decryption processor connected to said control processor for decrypting the data from the protected media item prior to providing it to said host device.

18. The system of claim 1, wherein said hardware decryption module further comprises a decryption processor connected to said control processor for decrypting the data from the protected media item prior to providing it to said host device.

19. The system of claim 1, wherein said hardware decryption module comprises a case having a surface in which a plug is formed for connection to said host device, said case having a socket formed therein for receiving the smart token.

20. The system of claim 1, wherein said hardware decryption module comprises a case, a plug for connection to said host device, and a cable interconnecting said case and said plug, said case having a socket formed therein for receiving the smart token.

21. The system of claim 1, wherein said hardware decryption module functions as a universal serial bus (USB) hub between said host device and said smart token, said hardware decryption module having a plug connectable to said host device and a socket for receiving said smart token.

22. The system of claim 1, wherein said host device sends to said hardware decryption module at least one of an initialize decrypt command, a decrypt data block command, a make copy command, and a retrieve player digital identifier (PDI) command.

23. The system of claim 1, wherein said hardware decryption module sends to said host device at least one of returned decrypted data, a returned encrypted record, and a returned hardware decryption module player digital identifier.

24. The system of claim 1, wherein said hardware decryption module comprises a self-contained device which is tamperproof so as to prevent compromise and copying of information stored therein.
